(19) United States
(12) Patent Application Publication
(10) Pub. No.: US 2009/0093144 A1
(43) Pub. Date: Apr. 9, 2009

(54) Electrical card connector assembly

(75) Inventor: Yung-Chang Cheng, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/287,461

(22) Filed: Oct. 8, 2008

(30) Foreign Application Priority Data
Oct. 8, 2007 (TW) 96216790

(51) Int. Cl. H01R 12/00

(52) U.S. Cl. 439/79

(57) ABSTRACT

An electrical card connector (2) having an insulative housing (22), a shell (21) covering on the insulative housing, a plurality of terminals (24) received in the insulative housing and a PCB (2) defining a pair of holes (31), said insulative housing and the shell form a card receiving space (221), the plurality of terminals define a plurality of contacting portions and soldering portions, and the contacting portions exposing in the card receiving space, the soldering portion extending beyond an end of the electrical card connector, wherein the electrical card connector (2) vertically assembling on the PCB (3), said insulative housing further defining a pair of T-type supporters (226), and each of T-type supporters forming a post (227), the pair of posts receiving in said holes, respectively, the pair of T-type of supporters standing on the PCB.

### BACKGROUND OF THE INVENTION

1. Field of the Invention

The present invention relates to an electrical card connector, and in particular to an electrical card connector for perpendicularly electrically connecting a card with a printed circuit board.

2. Description of Prior Arts

Generally, a conventional card connector is parallel assembled on a printed circuit board (PCB), i.e., the insertion direction of an inserted card being parallel with the PCB. As a result, the card connector occupies a large horizontal space above the PCB. In order to save horizontal space above a PCB, an electrical card connector assembled on the PCB is disclosed in U.S. Pat. No. 6,095,868. However, the electrical card connector assembly needs a transition connector mounted on a PCB for connecting the electrical card connector to the PCB, as a result, more vertical space is occupied by the transition connector and further the manufacturing cost is higher.

Therefore, it is desirable to provide a card connector that eliminates the aforesaid problems.

### SUMMARY OF THE INVENTION

Accordingly, an object of the present invention is to provide an electrical card connector which saves horizontal space above a printed circuit board on which the electrical card connector is mounted.

In the exemplary embodiment of the invention, an electrical card connector assembly comprising: an insulative housing forming a card receiving space; a shell covering on the insulative housing; a plurality of terminals being received in the insulative housing and each defining a contacting portion and a soldering portion, the contacting portions exposed in the card receiving space, the soldering portions extending beyond an end of the insulative housing; and a printed circuit board (PCB) defining a pair of holes; wherein the electrical card connector is vertically assembled on the PCB, said insulative housing further defining a pair of T-type supporters, and each of the T-type supporters forming a post, the pair of posts receiving in said holes, respectively, the pair of T-type supporters standing on the PCB.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical card connector assembly in accordance with the present invention;

FIG. 2 is a partly exploded view of the electrical card connector assembly;

FIG. 3 is an exploded view of the electrical card connector assembly; and

FIG. 4 is a partly exploded view of the electrical card connector.

### DETAILED DESCRIPTION OF THE PREFERRED EMBODIMENT

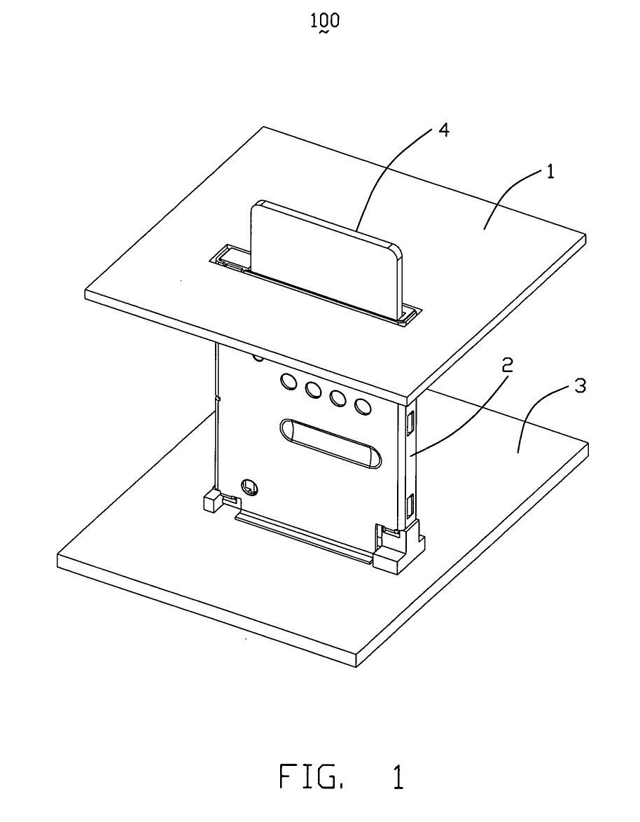

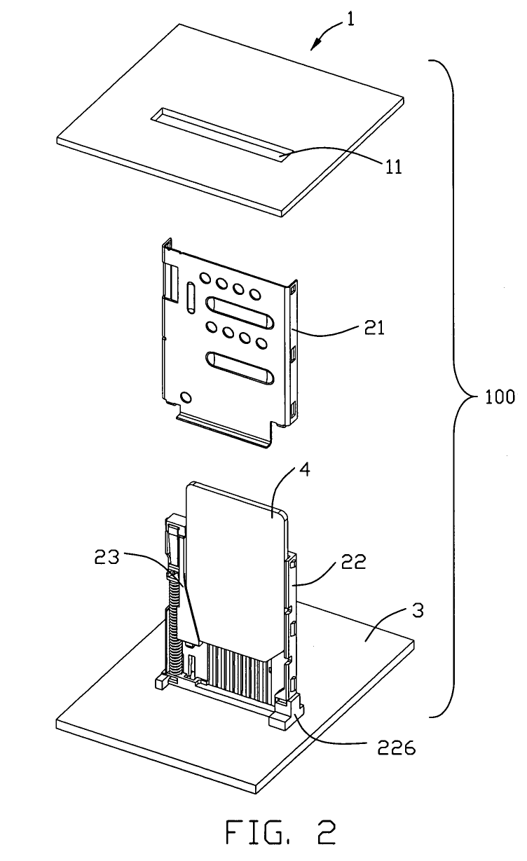

Referring to FIGS. 1 and 2, an electrical card connector assembly 100 comprises an upper cover 1, an electrical card connector 2 and a printed circuit board (PCB) 3 on which electrical card connector 2 is mounted.

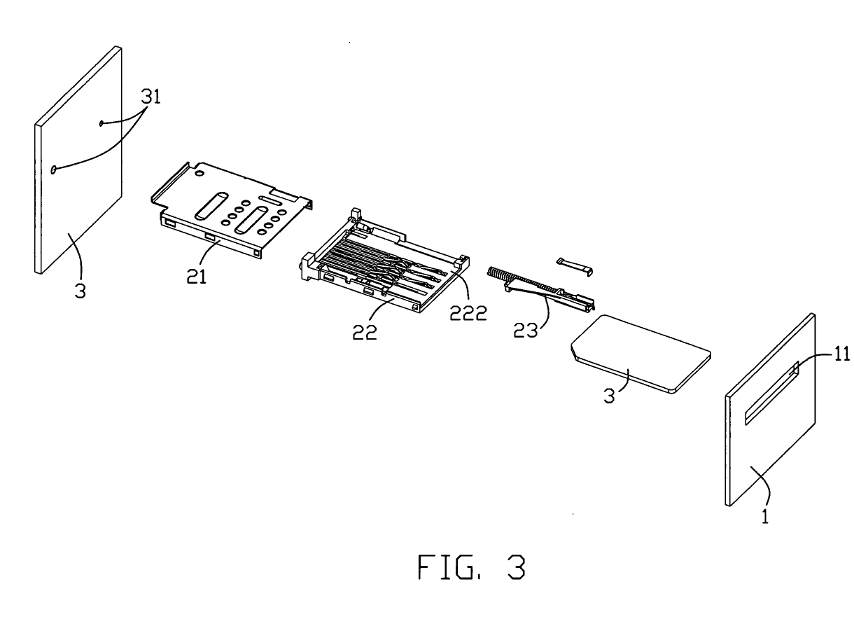

Referring to FIGS. 2 and 3, the upper cover 1 defines a cutout 11, and the upper cover 1 shown in the FIG. 2 is a part of the all cover.

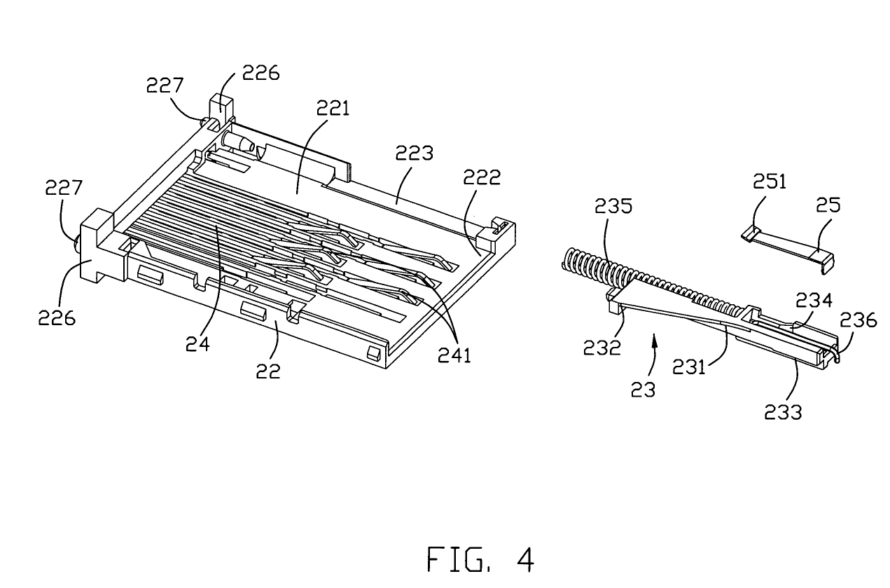

Referring to FIGS. 2 to 4, the electrical card connector 2 comprises a shell 21, an insulative housing 22, an ejector 23 and a plurality of terminals 24 receiving in the housing 22. The insulative housing 22 define a card receiving space 221, and is configured of rectangular, an inserting opening 222 is defined at an end of the insulative housing 22. an electrical card inserts into the card receiving space 221 via the inserting opening 222. Said terminals include contacting portions 241 and soldering portion (not shown), the contacting portions 241 expose in said card receiving space 221 and the soldering portions extend beyond the other end of the insulative housing 22. the contacting portion 241 electrical connecting with the electrical card inserted into the card receiving space 221.

The ejector 23 assembles in a lateral side of the insulative housing 22, the ejector 23 comprises a driving portion 231, a spring 235 and a cam follower 236. The driving portion 231 comprises a slider 233 and an ejecting portion 232 extending from said slider 233. The slider 233 defines a cam groove 234. The insulative housing 22 defines a slideway 223 for sliding the slider 233, and the ejecting portion 232 exposes in said receiving space 221. The spring 235 is disposed between the slider 233 and the insulative housing 22 to provide energy to drive the slider 233. An end of the cam follower 236 disposes in the insulative housing 22, and the other end of the cam follower 236 is slideably received in the cam groove 234, and the cam groove 234 cooperate with the cam follower 236 in locking the driving portion 231 at a first position and a second position as the cam follower 236 sliding at a given position. An elastic tab 25 assembles on the insulative housing 22, and the tab has a free end 251, the free end 251 presses on the cam follower 236 to make the cam follower 236 slide in the cam groove 234 stably. As the electrical card inserting into the card receiving space 221, the electrical card engages with the ejecting portion 232 and drives the driving portion 231 to move forward. After the electrical card fully inserting in the card receiving space 221, the driving portion 231 is locked at the second position by the cam follower 236. As we push the end of the electrical card again, the electrical card is ejected from the card receiving space 221 by the driving portion 231, and the driving portion 231 returns to the first position driven by the spring 235.

Referring to FIG. 2, the shell 21 covers on the insulative housing 22, and the opposite lateral sides of the shell 21 and the insulative housing 22 define locking structures, respectively, and the locking structures can lock with each other, the shell 21 acts as a wall of the electrical connector 2.

Referring to FIG. 2 to FIG. 4, the insulative housing 22 defines a pair of T-type supporters 226 at the end of the insulative housing 22 opposite to the inserting opening 222, each of the T-type supporter 226 forms a post 227 extending from said T-type supporter 226. The electrical connector 2 vertically assembles to said PCB 3, the PCB 3 defines a pair of holes 31 correspond said pair of posts 227, respectively. The pair of T-type supporters 226 dispose on the PCB 3, and the pair of the T-type supporters 226 help the electrical connector 2 keep perpendicularly to the PCB 3.

The upper cover 1 disposes on the inserting opening 222, and the cutout 11 of the upper cover 1 corresponds to the inserting opening 222. And the upper cover 1 is parallel with the PCB 3.

Accordingly, the electrical card connector 2 is vertically assembled on the PCB 3 so that horizontal space above the PCB is notably saved. And the highness of the electrical card connector 2 approaches to a thickness of a lap computer, and than the electrical card connector 2 can be assembled to the lap computer vertically.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. An electrical card connector assembly comprising:
an electrical card connector comprising:
an insulative housing forming a card receiving space;
a shell covering on the insulative housing;
a plurality of terminals being received in the insulative housing and each defining a contacting portion and a soldering portion, the contacting portions exposed in the card receiving space, the soldering portions extending beyond an end of the insulative housing; and
a printed circuit board (PCB) defining a pair of holes;
wherein the electrical card connector is vertically assembled on the PCB, said insulative housing further defining a pair of T-type supporters, and each of the T-type supporters forming a post, the pair of posts receiving in said holes, respectively, the pair of T-type supporters standing on the PCB.

2. The electrical card connector assembly as claimed in claim 1, further comprising an ejector having a driving portion, a spring and a cam follower, and the driving portion comprises an ejecting portion and a slider, the slider defines a cam groove.

3. The electrical card connector assembly as claimed in claim 2, wherein the insulative housing forms a slideway for sliding the slider, and the ejecting portion inserts in the card receiving, on end of the cam follower is received in the insulative housing the other end slideably received in the cam groove, the spring is disposed between the slider and the housing to provide energy.

4. The electrical card connector assembly as claimed in claim 3, wherein the insulative housing has an elastic tab, the elastic tab has a free end, the free end press on the cam follower.

5. The electrical card connector assembly as claimed in claim 1, wherein the electrical card connector has an inserting opening, and an upper cover is adjacent to the inserting opening.

6. The electrical card connector assembly as claimed in claim 5, wherein the upper cover defines a cutout, and the cutout corresponds to the inserting opening.

7. The electrical card connector assembly as claimed in claim 6, wherein the upper cover is parallel to the PCB.

8. The electrical card connector assembly as claimed in claim 1, wherein the contacting portion is arranged in two rows.

9. An electrical connector assembly for use with an electronic card, comprising:
a printed circuit board;
an electrical card connector upstanding upon the printed circuit board via a lower end section thereof in a vertical direction, said connector defining a pair of guiding arms opposite to each other in a first transverse direction perpendicular to said vertical direction for guiding insertion of the card, a plurality of contacts extending into a card receiving cavity defined between said guiding arms;
a cover positioned around an upper end of the connector and defining a slot in alignment with the card receiving cavity in said vertical direction so as to allow the card to be inserted into the card receiving cavity.

10. The electrical card connector assembly as claimed in claim 9, wherein one of said guiding arms is formed by an ejector device for ejecting the inserted card.

11. The electrical card connector assembly as claimed in claim 9, wherein the contacts defines the contacting sections extending into an upper half portion of said card receiving cavity.

12. The electrical card connector assembly as claimed in claim 9, wherein said connector includes an insulative main body cooperating with a metallic shell, which is opposite to the main body in a second transverse direction perpendicular to both said first transverse direction and said vertical direction, to define a primary plane of said card receiving cavity.

13. The electrical card connector assembly as claimed in claim 9, wherein an ejector device moves along one of said guiding arms.

14. The electrical card connector assembly as claimed in claim 9, wherein a spring is equipped with the ejector device.

15. An electrical card connector assembly for use with a card, comprising:
a printed circuit board;
an electronic card connector vertical mounted upon the printed circuit board and defining an upward card receiving cavity with a plurality of contacts extending therein;
a cover spaced from the printed circuit board and located above the electronic card connector; wherein
the cover defines a slot in vertical alignment with the card receiving cavity.

16. The electrical card connector assembly as claimed in claim 15, wherein a bottom end of the electronic card connector defines a pair of T-shaped structures in a symmetrical manner along both a long side and a short side of said bottom end.

17. The electrical card connector assembly as claimed in claim 16, wherein said contacts are mounted to the printed circuit board and asymmetrical on the short side.

18. The electrical card connector assembly as claimed in claim 15, wherein the contacts define contacting sections to engage the card at an upper half of the card receiving cavity.

19. The electrical card connector assembly as claimed in claim 15, wherein the connector includes an insulative main body in which the contacts are disposed, and a metallic shell opposite to the main body to cooperate with each other for forming said card receiving cavity.
